(19) United States
(12) Patent Application Publication
(10) Pub. No.: US 2002/0112383 A1
(43) Pub. Date: Aug. 22, 2002

(54) Display device

(76) Inventor: Trevor Butcher, Taunton (GB)

Correspondence Address: Ira S. Dorman, Suite 200, 330 Roberts Street, East Hartford, CT, 06108, US

(21) Appl. No.: 10/075,973

(22) Filed: Feb. 14, 2002

(30) Foreign Application Priority Data
Feb. 19, 2001 (GB) 01 03 922.1

(51) Int. Cl. G09F 19/00

(52) U.S. Cl. 40/406; 40/439

(57) ABSTRACT

Superimposed light-transmitting walls 10-13 define intervening chambers 14-16 containing differently colored liquids, and discreet volumes of gas are introduced into a bottom region of each chamber such that rising volumes of gas present moving differently colored areas to an observer looking through the walls. The display area is increased by forming liquid reservoirs 20-22 at the top of each chamber, with anti-spill valves 30-32 which admit or release air when a preset pressure differential is exceeded. A positive displacement pump recirculates gas from the reservoirs to respective inlets 34-36 at the bottom of the chambers. Gas flow separators are provided adjacent to the inlets, and the chambers have side spacers with inward projections to prevent volumes of gas from tracking up the sides of the chamber.

### TECHNICAL FIELD OF THE INVENTION

This invention relates to display devices of the kind which include a plurality of superimposed light-transmitting walls defining at least one intervening chamber containing a first fluid (e.g. a liquid), and inlet means for introducing discreet volumes of a second fluid (e.g. a gas) into a bottom region of the or each chamber, the two fluids being immiscible and distinguished by colour, and the second fluid having a lower density than the first such that rising volumes of the second fluid in the respective chamber present moving differently coloured areas to an observer looking through the walls.

### BACKGROUND

Such display devices are described in U.S. Pat. No. 3,706,149 and U.S. Pat. No. 3,964,194. However, the known devices are only suitable for producing relatively small displays of limited height and area. Furthermore, they can only be used with viscous liquids, resulting in relatively slow-changing displays.

The present invention seeks to provide a new and inventive form of display device of the kind set forth in the opening paragraph, which is capable of producing large dynamic displays.

### SUMMARY OF THE INVENTION

The present invention proposes that an expansion reservoir for holding a reserve volume of the first fluid is provided at the top of the or each chamber. When the second fluid enters the chamber the first fluid is displaced into the reservoir to be returned to the chamber when the device is no longer functioning. It is thus possible to achieve a larger display area.

The invention further proposes that the display device includes a recirculation path for drawing the second fluid from the top of the or each chamber and conducting said fluid to the respective inlet means via a positive displacement pump. By recirculating the second fluid it is possible to provide a substantially sealed system to prevent spillage or leakage of fluid. Evaporation of liquid is also reduced so that less frequent maintenance is required. Although some systems may be completely sealed, when one of the fluids is a gas an anti-spill valve system is preferably provided at the top of the or each chamber to admit or release gas when a preset internal-external pressure differential is exceeded.

In a display device which includes a plurality of chambers each preferably has a respective recirculation pump and the pumps are operated by a common motor. Such an arrangement ensures that the recirculation rates are balanced between the compartments and can be simultaneously controlled by adjusting the speed of the pump motor. If required, independent control over the flow rates can be achieved using a pump bypass passage which incorporates a variable restriction.

It is further proposed that the or each chamber contains a flow separator disposed adjacent to the inlet means. Such separators may be arranged to divide the inflow from a single relatively large inlet into separate transversely spaced volumes, thereby reducing the risk of inlet blockage.

Moreover, the invention proposes that the opposed side margins of the or each chamber are formed by non-linear rising contoured surfaces which are formed with inward projections which prevent volumes of gas from tracking vertically up the sides of the chamber.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a side view of a colour display device in accordance with the invention, shown shortened for convenience of illustration;

FIG. 2 is a general view of the three colour-change chambers of the display;

FIG. 3 is a front view of an air separator incorporated in each of the chambers;

FIG. 4 is a diagrammatic representation of an air recirculation system used with each of the chambers;

FIG. 5 is more detailed general view of the air recirculation system;

FIG. 6 is a sectional view of an alternative form of pump for use in the recirculation system;

FIG. 7 is a schematic diagram of an anti-spill valve for the display device; and

FIG. 8 is a schematic diagram of an alternative form of anti-spill valve.

### DETAILED DESCRIPTION OF THE DRAWINGS

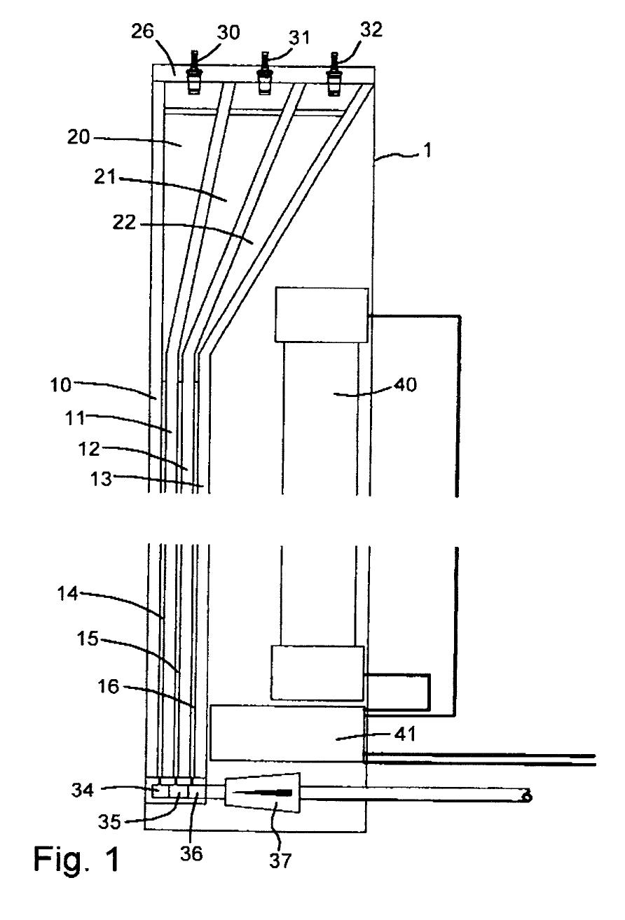

FIG. 1 shows a side view of a display device including a light-proof housing 1 the front of which is formed by four transparent non-coloured plastic walls 10-13 separated by a uniform gap of about 1.5 mm (preferably 1 to 2 mm) forming three chambers 14-16. The front wall 10 is substantially planar but the remaining walls are inclined rearwardly adjacent to their upper ends at increasing angles to form three wedge-shaped reservoirs 20-22. The chambers are filled with different coloured translucent liquids, e.g. cyan, yellow and magenta, leaving an air gap adjacent to the top of each reservoir.

Low viscosity liquids are used, e.g. water coloured with ink. The tops of the reservoirs are sealed by a top panel 26 which contains three anti-spill valves 30-32, described in more detail below.

Behind the four walls 10-13 there is at least one flourescent tube 40 of the kind which emits white light. To spread the light a diffuser screen (not shown) can be provided between the tube and the transparent walls, or a reflector can be mounted to the rear and sides of the lamp. The tube is operated from an electronic control box 41 mounted at the bottom of the housing.

At the bottom of each chamber there is a respective air inlet pipe 34-36, each containing a non-return valve 37, for introducing gas into the three chambers. When gas enters the chambers it forms discreet flattened colourless bubbles which rise through the coloured liquid and filter the light from the tube 40 to present various colours as the bubbles overlap in different combinations. When gas enters the chambers the liquids are temporarily displaced into the three reservoirs 20-22.

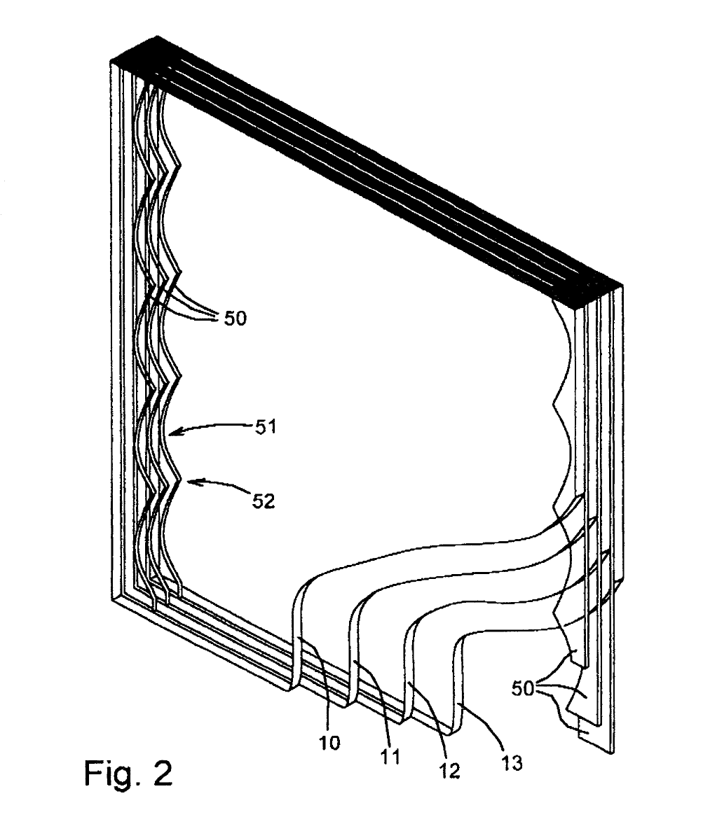

If the sides of the chambers are straight it has been found that the gas bubbles tend to track vertically along the sides of the chambers. This can be reduced and colour variations increased using the arrangement shown in FIG. 2. The walls 10-13 are sealed at their vertical margins by spacers 50. The opposed internal faces of the spacers are of wave-like configuration with contiguous concave indentations 51 forming angular projections 52, which has been found to prevent the tracking problem referred to.

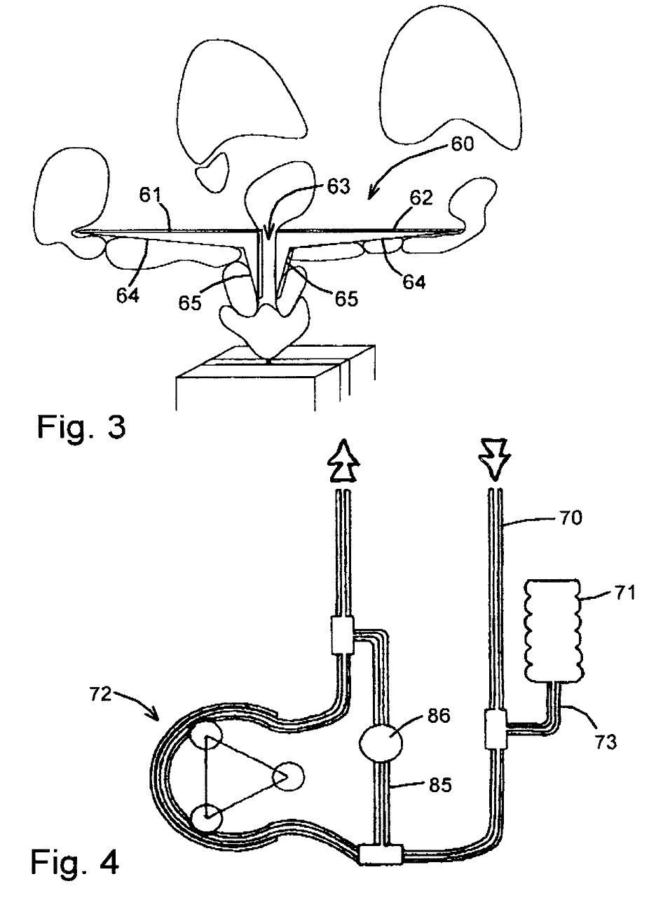

In order to create random colour changes distributed uniformly across the width of the chambers each chamber preferably contains a gas separator disposed adjacent to a relatively large gas inlet at the bottom of the chamber, as shown in FIG. 3. Each gas separator 60 includes a pair of arms 61 and 62 separated by a vertical passage 63 spaced immediately above the respective air inlet. At their adjacent ends the arms have downwardly-directed angular dividers 65 which split the emergent air bubbles causing part of the air flow to travel along upwardly-inclined bottom faces 64 of the arms 61 and 62. Thus, bubbles of gas are caused to rise on either side of the inlet as well as immediately above.

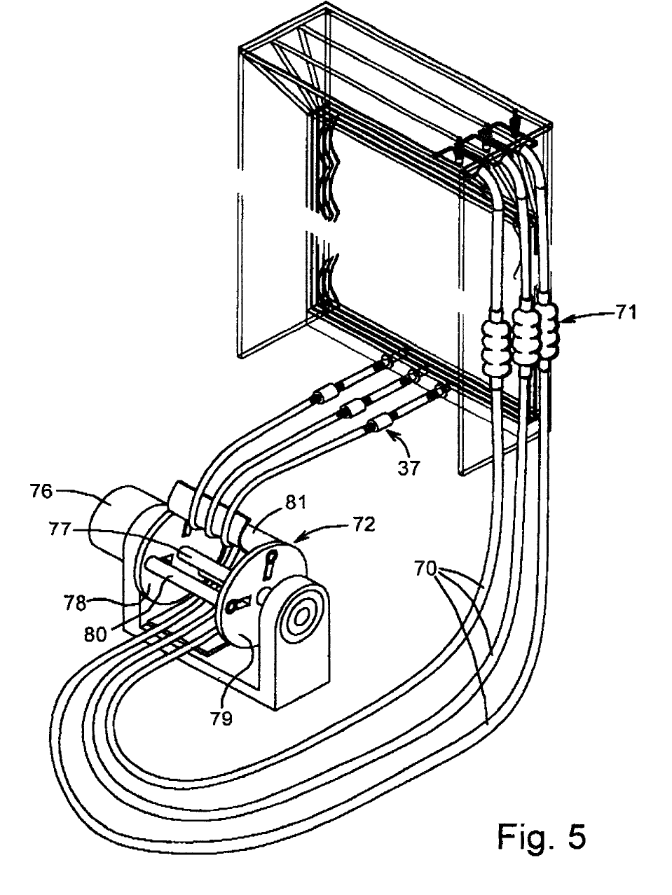

Air from the top of the reservoirs is recirculated to the air inlets via a closed pipe system shown diagrammatically in FIG. 4. The air passes through a pipe 70 via an expansion chamber 71, which may be connected in-line or connected to the pipe 70 via a branch pipe 73, before passing through a peristaltic pump 72. One form of suitable pump is shown in FIG. 5. The pump comprises an electric motor 76 which drives a shaft 77 on which are mounted two spaced discs 78 and 79. Three rollers 80 are mounted between the discs 78 and 79 to act against an arcuate pinch plate 81. The three pipes from the three chambers are all interposed between the rollers and the pinch plate so that air is displaced simultaneously through the three pipes. The speed of the motor can be controlled electronically. Independent flow control can be provided by providing a pump bypass passage 85 (FIG. 4) which incorporates a variable restriction 86

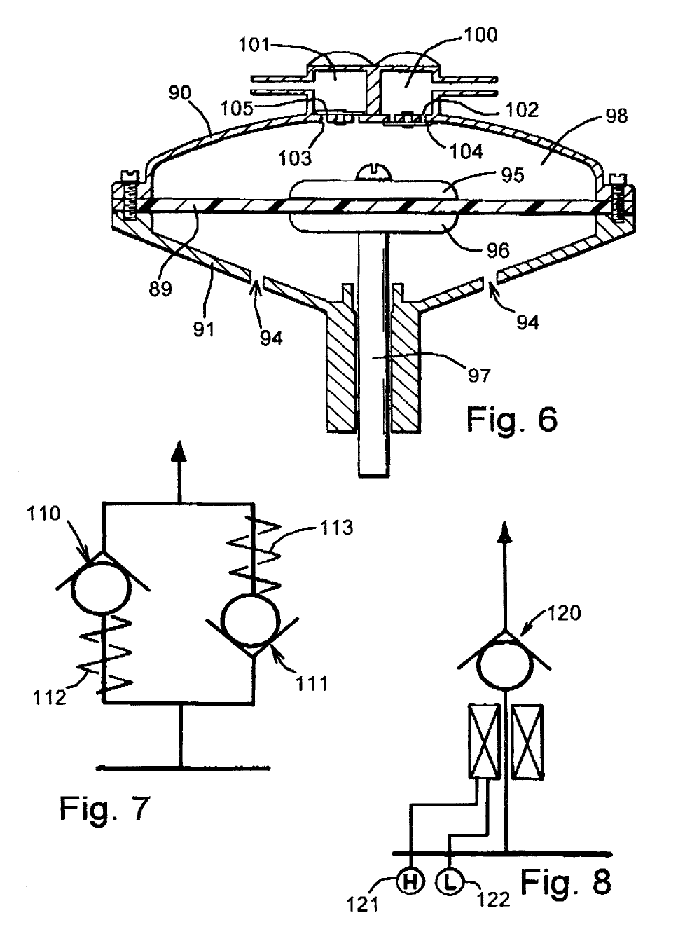

FIG. 6 shows an alternative form of pump 72. A diaphragm 90 is entrapped between two case parts 90 and 91, and one side of the diaphragm is open to atmosphere via ports 94. The centre of the diaphragm 90 is held between discs 95 and 96 which are secured to a push rod 97 extending axially from the housing. A motor-driven cam (not shown) reciprocates the push rod 97 to move the diaphragm, thereby varying the volume within a pumping chamber 98. One of the case parts 90 is formed with inlet and outlet chambers 100 and 101 which communicate with the pumping chamber via ports 102 and 103 respectively which are in turn covered by flexible valve elements 104 and 105. The inlet valve element 104 is arranged to admit air into the chamber 98 from an inlet port whereas the element 105 allows air to exit from the chamber on the return movement of the diaphragm 90. One such pump would be required for each of the chambers 14-16, although the they may all be operated from a common motor.

Under normal circumstances the anti-spill valves 30-32 prevent loss of liquid from the chambers if the device is tilted so that the chambers are effectively sealed. However, the valves ensure that the air pressure within each chamber approximates to atmospheric pressure. Referring to FIG. 7, each of the valves may include a pair of oppositely-acting valve elements 110 and 111 which act against the force of spring elements 112 and 113 to move away from their respective seatings when a preset threshold pressure is exceeded. The elements 110 and 111 may be combined into a common valve assembly or mounted separately. An alternative form of valve which is shown in FIG. 8 may utilise a single solenoid-operated valve 120 which opens to atmosphere in response to high and low pressure sensors 121 and 122 within the respective compartment.

A mercury tilt switch can be incorporated to disconnect power from the pump and light if the device should tip over while in operation.

Although this example uses a liquid and a gas, two immiscible liquids of different densities could be used.

The arrangement described has a number of advantages, which include the following:

The gap between the walls can be made very small.

The area of the gas bubbles is increased for a given gas volume.

Brighter and more vivid colours are created.

The height of the display area can be increased.

Less liquid is used so that the device is cheaper, lighter and presents less of a problem if leakage should occur.

A smaller capacity pump can be used.

Low viscosity liquids can be used and more rapid colour changes can therefore be achieved.

Greater shape variation and movement of the gas spaces is achieved.

Less frequent maintenance and fluid replacement is required.

It will be appreciated that the features disclosed herein may be present in any feasible combination. Whilst the above description lays emphasis on those areas which, in combination, are believed to be new, protection is claimed for any inventive combination of the features disclosed herein.

1. A display device of the kind which includes a plurality of superimposed light-transmitting walls defining at least one intervening chamber containing a first fluid, and inlet means for introducing discreet volumes of a second fluid into a bottom region of the or each chamber, the two fluids being immiscible and distinguished by colour, and the second fluid having a lower density than the first such that rising volumes of the second fluid in the respective chamber present moving differently coloured areas to an observer looking through the walls, in which an expansion reservoir for holding a reserve volume of the first fluid is provided at the top of the or each chamber.

2. A display device according to claim 1, in which the or each reservoir is integrally formed with the respective chamber.

3. A display device according to claim 2, in which the or each reservoir is formed by a pair of divergent upper wall portions of the respective chamber.

4. A display device according to claim 1, which includes a recirculation path for drawing the second fluid from the top of the or each chamber and conducting said fluid to the respective inlet means via a positive displacement pump.

5. A display device according to claim 4, in which an expansion vessel is connected into the recirculation path.

6. A display device according to claim 4, which includes a plurality of chambers each having a respective recirculation pump, and the pumps are operated by a common motor.

7. A display device according to claim 6, in which each recirculation pump is provided with a bypass passage which incorporates a variable restriction.

8. A display device according to claim 1, in which the or each chamber contains a flow separator disposed adjacent to the inlet means.

9. A display device according to claim 8, in which the or each flow separator is arranged to divide the fluid inflow from the respective inlet into a plurality of transversely spaced volumes.

10. A display device according to claim 8, in which the or each flow separator has a pair of outwardly extending arms separated by a gap.

11. A display device according to claim 10, in which the adjacent ends of the arms are provided with depending limbs which protrude into the emerging fluid space.

12. A display device according to claim 1, in which the opposed side margins of the or each chamber are formed by non-linear rising contoured surfaces which are formed with inward projections.

13. A display device according to claim 1, in which the first fluid is a liquid and the second fluid is a gas.

14. A display device according to claim 13, in which an anti-spill valve system is provided at the top of the or each chamber to admit or release gas when a preset internal-external pressure differential is exceeded.

15. A display device according to claim 13, in which the first fluid is a low viscosity liquid.
